(19) United States
(12) Patent Application Publication
(10) Pub. No.: US 2008/0205571 A1
(43) Pub. Date: Aug. 28, 2008

(54) System and Method for Time Aligning Signals in Transmitters

(76) Inventors: Khurram Muhammad, Dallas, TX (US); Khurram Waheed, Plano, TX (US)

Correspondence Address: TEXAS INSTRUMENTS INCORPORATED, P O BOX 655474, M/S 3999, DALLAS, TX, 75265, US

(21) Appl. No.: 11/967,984

(22) Filed: Dec. 31, 2007

Related U.S. Application Data
(60) Provisional application No. 60/891,916, filed on Feb. 27, 2007.

(51) Int. Cl. H04L 7/00

(52) U.S. Cl. 375/376; 375/371

(57) ABSTRACT

A system and method for time aligning signals in transmitters. A transmitter includes a first signal path coupled to a first data input, a second signal path coupled to a second data input, an error signal energy source coupled to the first and second signal paths, the error signal energy source generates an error signal responsive to a time alignment difference between a first data stream and a second data stream, a time alignment circuit coupled to the error signal energy source, to the first and second data inputs, the time alignment circuit generates a digital control word responsive to the error signal, to the first and second data streams, and a timing adjust unit coupled to the time alignment circuit, to the first and second signal paths, the timing adjust unit inserts a delay proportional to the digital control word in either signal paths.

This application claims the benefit of U.S. Provisional Application No. 60/891,916, filed on Feb. 27, 2007, entitled “A Method and Apparatus for Adaptive Equalization of the I/Q or RHO/THETA Imbalance in a Transmitter,” which application is hereby incorporated herein by reference.

### TECHNICAL FIELD

The present invention relates generally to a system and method for communication systems, more particularly to a system and method for time aligning signals in transmitters.

### BACKGROUND

Modem communications standards, such as Enhanced Data for GSM Evolution (EDGE), Wideband Code Division Multiple Access (WCDMA), Bluetooth—Enhanced Data Rate (BT-EDR), Wireless Local Area Network (WLAN), Worldwide Interoperability for Microwave Access (WiMAX), Long-Term Evolution (LTE), and so forth, impose strict performance requirements on transceivers. For example, for a transmitter utilizing a polar transmitter, stringent performance requirements exist for modulated close-in and far-out spectra, adjacent channel power/leakage ratio (ACPR/ACLR), error vector magnitude (EVM), phase trajectory error (PTE), percentage power in-band, and so on.

It may be possible to implement such modern communications standards using digital polar modulation or quadrature modulation if precise time alignment may be maintained between signal paths, such as an amplitude modulation (AM) path and a phase/frequency modulation (PM/FM) path in polar modulation transceivers or an in-phase (I) path and a quadrature phase (Q) path in quadrature modulation transceivers. For example, in a digital polar modulation transmitter, this may be a difficult task since both amplitude and phase (or frequency) paths comprise digital components that may operate on different clock domains in a design optimized for power efficiency. The individual clock domains may themselves by synchronized to a reference. However, the time alignment resolution may be inadequate. This may be additionally pertinent in scenarios wherein there is a differential skew between two paths due to digital to analog to RF timing uncertainties. Analog delays in the signal paths, such as the amplitude modulation path and the phase/frequency path, have independent analog components. The delays through the analog components may vary independently with temperature and voltage. The independent variation in the delays may lead to difficulties in maintaining a match in delay between the signal paths.

A method and technique for time alignment in a digital polar transmitter has been described in a co-assigned patent application, U.S. Patent Publication No. 20070189417-A1, entitled “Precise Delay Alignment Between Amplitude and Phase/Frequency Modulation Paths in a Digital Polar Transmitter” and is hereby incorporated herein by reference.

### SUMMARY OF THE INVENTION

These and other problems are generally solved or circumvented, and technical advantages are generally achieved, by embodiments of a system and a method for time aligning signals in transmitters.

In accordance with an embodiment, a transmitter having two signal paths is provided. The transmitter includes a first signal path coupled to a first data input, a second signal path coupled to a second data input, an error signal energy source coupled to the first signal path and to the second signal path, a time alignment circuit coupled to the error signal energy source and to the first data input and to the second data input, and a timing adjust unit coupled to the time alignment circuit and to the first signal path and to the second signal path. The first signal path processes a first data stream for transmission, the second signal path processes a second data stream for transmission, the error signal energy source generates an error signal responsive to a time alignment difference between the first data stream and the second data stream. The time alignment circuit generates a digital control word responsive to the error signal and to the first data stream and to the second data stream, and the timing adjust unit inserts a delay proportional to the digital control word in either the first signal path or the second signal path.

In accordance with an embodiment, a method for adjusting a time alignment between separate signal paths is provided. The method includes computing a signal metric from data carried on the separate signal paths, generating a digital control word from the signal metric, and adjusting a delay in one or more of the separate signal paths responsive to the digital control word.

In accordance with another embodiment, a method for adjusting a time alignment between separate signal paths is provided. The method includes characterizing the separate signal paths over a variety of conditions to produce delay settings for the separate signal paths, saving the delay settings, determining operating conditions, retrieving delay settings based on the operating conditions, and applying the delay settings to the separate signal paths.

An advantage of an embodiment is that the time alignment of separate signal paths may be achieved and maintained under a wide variety of operating environments and conditions.

A further advantage of an embodiment is that the time alignment of separate signal paths may be achieved for signal paths having very high operating frequencies, enabling time alignment in high speed operations.

The foregoing has outlined rather broadly the features and technical advantages of the present invention in order that the detailed description of the embodiments that follow may be better understood. Additional features and advantages of the embodiments will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the embodiments, and the advantages thereof, reference is now made to the following descriptions taken in conjunction with the accompanying drawings, in which:

FIG. 1 is a diagram of a wireless communications device;

FIG. 2 is a diagram of a small-signal polar transmitter;

FIG. 3a is a data plot of the effects of time alignment between amplitude and phase samples for an EDGE adherent transmitter;

FIG. 3b is a data plot of the effects of time alignment between amplitude and phase samples for an EDGE adherent transmitter;

FIG. 4a is a data plot of the effects of time alignment between amplitude and phase samples for a WCDMA adherent transmitter;

FIG. 4b is a data plot of the effects of time alignment between amplitude and phase samples for a WCDMA adherent transmitter;

FIG. 5 is a diagram of a digital polar transmitter using on-chip receiver feedback for adaptive time alignment;

FIG. 6a is a diagram of a timing adjust unit for fine time-alignment;

FIG. 6b is a diagram of a timing adjust unit for fine time-alignment;

FIG. 7 is a diagram of a Cartesian transmitter;

FIG. 8 is a diagram of a digital polar transmitter using direct self calibration of timing alignment of amplitude and phase modulation signal paths;

FIG. 9a is a diagram of a small signal polar transmitter;

FIG. 9b is a diagram of a large signal polar transmitter

FIG. 10 is a diagram of a sequence of events for use in adjusting of time alignment; and

FIG. 11 is a diagram of a sequence of events for use in adjusting of time alignment.

### DETAILED DESCRIPTION OF ILLUSTRATIVE EMBODIMENTS

The making and using of the embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The embodiments will be described in a specific context, namely a wireless communications device adherent to a 2G or 3G cellular communications standard, such as Enhanced Data for GSM Evolution (EDGE), Wideband Code Division Multiple Access (WCDMA), Bluetooth—Enhanced Data Rate (BT-EDR), Wireless Local Area Network (WLAN), Worldwide Interoperability for Microwave Access (WiMAX), Long-Term Evolution (LTE), and so forth. The invention may also be applied, however, to other wireless communications devices adherent to other communications standards, wherein there is a desire to time align signals in data paths with a high degree of precision. Furthermore, the invention may be applied to circuits having multiple independent signal paths, wherein there is a desire to time align signals in the signal paths.

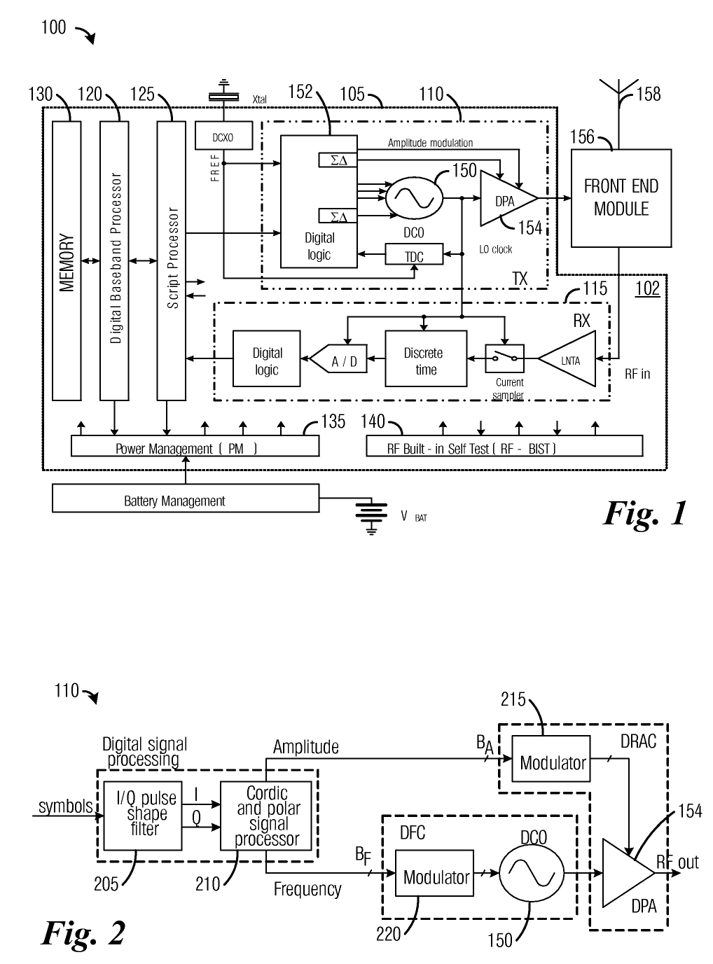

With reference now to FIG. 1, there is shown a diagram of a wireless communications device 100 containing a radio integrated circuit chip 102. The radio integrated circuit chip 102 further contains a polar transceiver 105. The polar transceiver 105 includes a transmitter 110 and a receiver 115. The polar transceiver 105 also includes a digital baseband processor 120 to process signals to be transmitted and/or received by the polar transceiver 105, a script processor 125 to execute algorithms and functions in the polar transceiver 105, a memory 130 to store data, configuration parameters, programs, and so forth. The polar transceiver 105 further includes a power management circuit 135 to condition and stabilize a power supply for the polar transceiver 105 and radio frequency built-in self test circuit 140 to perform autonomous testing, such as phase noise and modulation distortion, as well as various loopback configurations for bit error rate measurements. Although the discussion focuses on a polar transmitter, the embodiments have application with other forms of transmitters, such as Cartesian transmitters. Therefore, the discussion of polar transmitters should not be construed as being limiting to either the scope or the spirit of the embodiments.

Central to the polar transceiver 105 is a digital controlled oscillator (DCO) 150. The DCO 150 deliberately avoids analog tuning controls. Fine frequency resolution may be achieved through high-speed sigma-delta (ΣΔ) dithering of varactors of the DCO 150. Digital logic 152 built around the DCO 150 realizes an all-digital PLL (ADPLL) that may be used as a local oscillator for both the transmitter 110 and the receiver 115. The polar architecture of the polar transceiver 105 may utilize a wideband direct frequency modulation capability of the ADPLL and a digitally controlled pre-power amplifier (DPA) 154 for power ramp and amplitude modulation. The DPA 154 may operate in near class E mode and makes use of an array of NMOS transistors to regulate the RF amplitude, for example, high-speed sigma-delta dithering of the NMOS transistors may achieve fine amplitude resolution of a transmitted signal.

The wireless communications device 100 also contains a matching network and an external front end module 156. The external front end module 156 comprises a power amplifier (PA) and either a duplexer or a transmit/receive switch for a common antenna 158. The receiver 115 may employ a discrete time architecture in which a received RF signal is directly sampled at Nyquist rate of the received RF signal's RF carrier and processed using analog and digital signal processing techniques.

FIG. 2 illustrates a high-level view of the transmitter 110. The transmitter 110 is a polar transmitter and implements a polar transmitter's amplitude modulation and phase modulation in separate paths. Data, in the form of symbols, to be transmitted may be generated in the digital baseband processor 120 and may be first pulse-shape filtered in a Cartesian coordinate system by an I/Q pulse-shape filter 205 and then converted using a Cordic algorithm in a signal processor 210 into amplitude and phase samples. The phase samples may then be differentiated to obtain a frequency deviation. The amplitude samples and the differentiated phase samples may then be modulated in modulators 215 (amplitude samples) and 220 (differentiated phase samples) using a RF carrier signal, such as a LO signal produced by the DCO 150 prior to being amplified by the DPA 154.

After Cordic processing in the signal processor 210, the amplitude samples and the phase samples may follow separate signal processing paths. Although care may be taken to perform symmetric signal processing operations, the different nature of the two signal processing paths may result in asymmetric signal processing steps. The separate amplitude and phase signal processing paths may have different delays. The digital signal processing of the two signal paths may have a relatively constant and predictable digital delay, which may be somewhat addressed by the structural design of the two data paths. For additional details, refer again to previously referenced US patent 20070189417-A1, titled “Precise Delay Alignment Between Amplitude and Phase/Frequency Modulation Paths in a Digital Polar Transmitter.”

Both the amplitude and phase modulation paths may undergo a digital to analog/RF transformation. For the phase/frequency path, this may occur at the DCO interface, where the switching of discrete varactors is transformed to the RF frequency change at the DCO output after passage through the DCO tank filtering. With the amplitude path, this transformation may occur at the output of the signal-delta amplitude modulator (SAM), wherein the row/column (address) decoding of the DPA 154 transforms into RF amplitude modulation of the phase modulated DCO output. For example, a delay through a phase modulation signal path of the transmitter 110 may undergo a relatively longer duration from the analog natured variations while the delay through an amplitude modulation signal path of the transmitter 110 may exhibit relatively less temporal variation due to its dominantly digital implementation. However, the analog delays in the phase and amplitude modulation signal paths may undergo changes with process, temperature, voltage, operational channel frequency, output power, and so forth.

However, desirable transmitter performance may be achieved only if the two separate signal processing paths are properly tuned so that absolute time alignment accuracy between the amplitude samples and the phase samples is achieved and maintained across the transmitter's operation. In many communications standards, complex modulation schemes may utilize both of the modulation paths in a polar transmitter (or the in-phase and quadrature phase modulation paths in a Cartesian transmitter) operating at relatively low clock rates to help ensure that time alignment may be maintained between the two separate signal paths. Although the discussion focuses on a transmitter with two separate signal processing paths, such as the amplitude and phase signal paths in a digital polar transmitter or the in-phase and quadrature phase signal paths in a Cartesian (or quadrature) transmitter, the embodiments may be applicable to circuits having any number of independent signal paths. Therefore, the discussion of transmitters having two separate signal paths should not be construed as being limiting to either the spirit or the scope of the embodiments.

However, for communications standards providing high speed transmitter operations, the two separate signal paths may experience time misalignment due to a need to perform asymmetric operations required for accurate amplitude and phase reconstruction. Furthermore, even in transmitter designs using similar and relatively low clock rates for the two separate signal paths, a clock tree delay for each path may be independent and thus may introduce clock skew, thereby increasing the time misalignment. Additionally, at a digital-to-analog interface, both the amplitude and the phase modulation paths may involve analog delays. The analog delays may be a function of manufacturing process, voltage, and temperature (PVT). Therefore, the analog delays may be unpredictable in nature and designers may not be able to sufficiently compensate for the analog delays.

These factors, and potentially others, may necessitate that time alignment requirements for each communications standard be analyzed and transmitter design be implemented to ensure that adequate time alignment be achieved. For example, a time alignment precision between amplitude samples and phase samples for an EDGE adherent transmitter may be on the order of a few nanoseconds (typically less than 10 nanoseconds), while for WCDMA and several 4G communications standards, the time alignment precision may need to be better than a nanosecond. If the time alignment precision is not met, severe performance degradation may occur in several critical transmitter performance parameters, such as, EVM and ACLR/ACPR, for example.

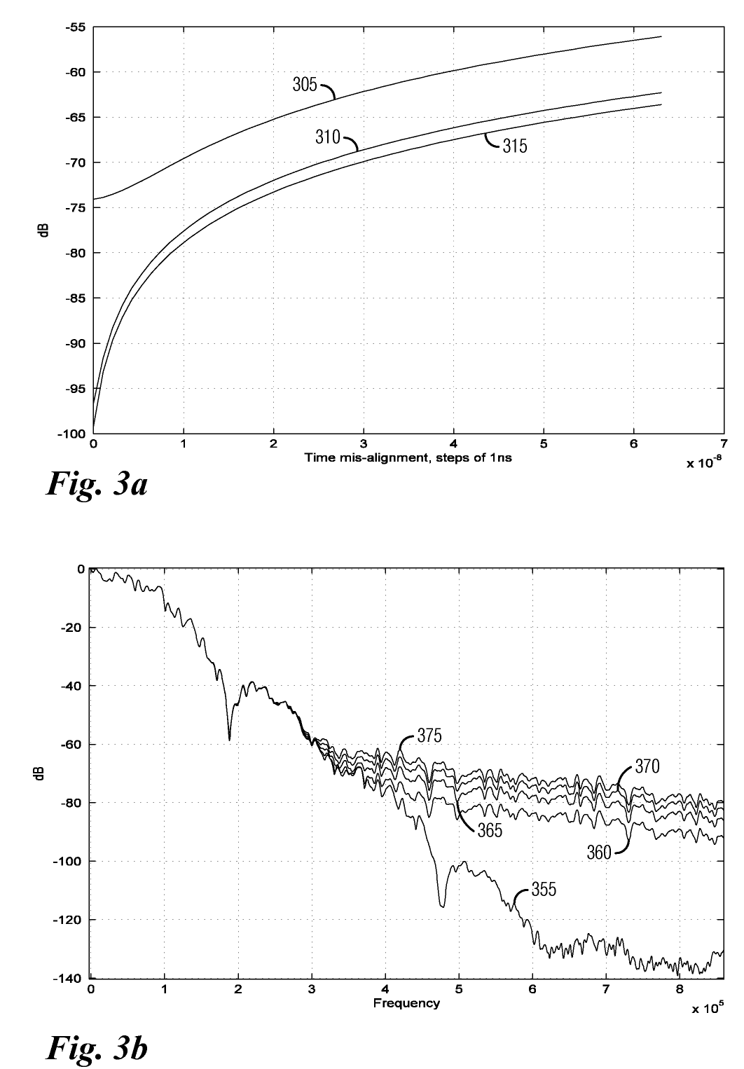

FIG. 3a illustrates a data plot of the effect of a time misalignment between amplitude and phase samples for an EDGE adherent transmitter. The time misalignment is varied from zero nanoseconds (perfect alignment) to 60 nanoseconds (severe misalignment) and is measured at several EDGE spectrum points. A first trace 305 illustrates the effect of time misalignment between amplitude and phase samples for an EDGE spectrum point of 400 KHz, a second trace 310 illustrates the effect of time misalignment between amplitude and phase samples for an EDGE spectrum point of 500 KHz, and a third trace 315 illustrates the effect of time misalignment between amplitude and phase samples for an EDGE spectrum point of 600 KHz. As shown in FIG. 3a, as the time misalignment increases, the performance of the EDGE adherent transmitter rapidly drops off. The modulated spectrum of a modulation standard may exhibit a greater sensitivity to time alignment for larger frequency offsets.

FIG. 3b illustrates a data plot of the effect of a time misalignment between amplitude and phase samples for an EDGE adherent transmitter. The frequency response is shown for a variety of different time misalignments. A first trace 355 illustrates the impact of a time misalignment of zero nanoseconds on the EDGE adherent transmitter, a second trace 360 illustrates the impact of a time misalignment of 6.4 nanoseconds on the EDGE adherent transmitter, a third trace 365 illustrates the impact of a time misalignment of 13.8 nanoseconds on the EDGE adherent transmitter, a fourth trace 370 illustrates the impact of a time misalignment of 19.2 nanoseconds on the EDGE adherent transmitter, and a fifth trace 375 illustrates the impact of a time misalignment of 25.8 nanoseconds on the EDGE adherent transmitter. As shown in FIG. 3b, the frequency response of the EDGE adherent transmitter rapidly drops off as the time misalignment increases.

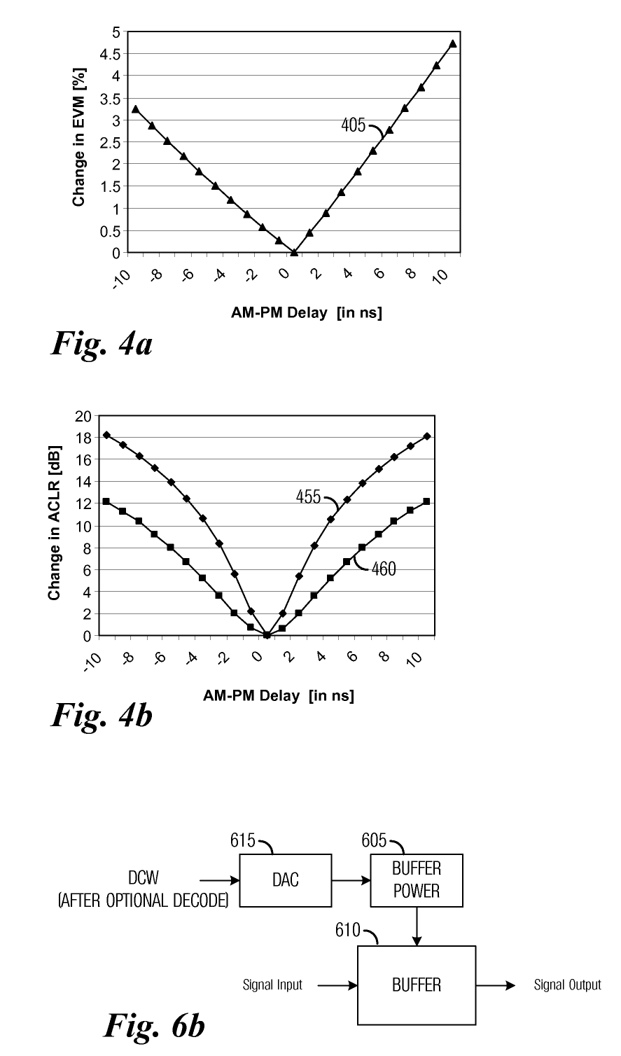

FIG. 4a illustrates a data plot of the effect of a time misalignment between amplitude and phase samples for a WCDMA adherent transmitter. A trace 405 illustrates a percentage change in EVM for a variety of time misalignments ranging from −10 nanoseconds to +10 nanoseconds. For WCDMA, both the phase and amplitude modulation bandwidths may be much higher than EDGE, therefore, the signal processor 210 typically operates at a significantly higher rate than for EDGE. Therefore, there may be an increased sensitivity to time misalignment in WCDMA adherent transmitters.

FIG. 4b illustrates a data plot of the effect of a time misalignment between amplitude and phase samples for a WCDMA adherent transmitter. A first trace 455 illustrates a change in dB for a first ACLR (ACLR1, i.e., modulated WCDMA spectrum at +5 MHz offset) for a variety of time misalignments ranging from −10 nanoseconds to +10 nanoseconds and a second trace 460 illustrates a change dB for a second ACLR (ACLR2, i.e., modulated WCDMA spectrum at +10 MHz offset) for a variety of time misalignments ranging from −10 nanoseconds to +10 nanoseconds.

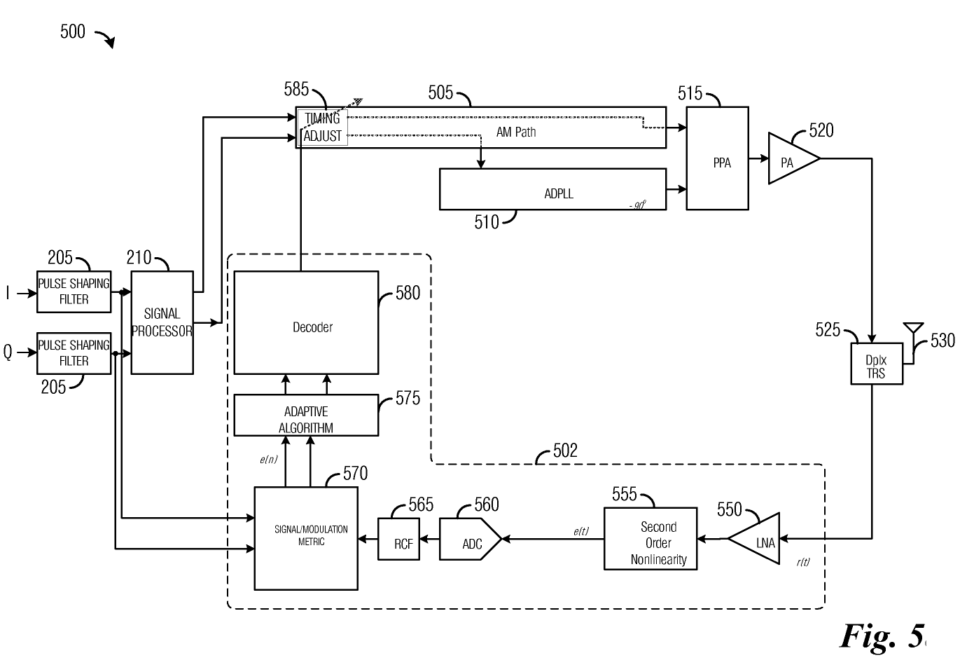

FIG. 5 illustrates a diagram of a digital polar transmitter 500 of a digital polar transceiver having an adaptive amplitude and phase signal path time alignment circuit (APTAC) 502. The diagram of the digital polar transmitter 500 is a high-level diagram, providing a block-level view of the digital polar transmitter 500. The digital polar transmitter 500 includes pulse shaping filters 205, one each for in-phase (I) and quadrature phase (Q) signal paths provided by a digital baseband processor, such as the digital baseband processor 120. The pulse shaping filters 205 may be used to band limit the I and Q signals, for example. The signal processor 210 may then be used to interpolate and convert the I and Q signals into amplitude and phase signals by implementing a Cordic algorithm.

The amplitude and phase signals may then be provided to separate signal paths. The amplitude signals may follow an AM signal path 505, while the phase signals may be provided to an all digital phase-locked loop (ADPLL) 5 10. After processing by the respective signal paths, the amplitude and phase signals may then be provided to a pre-power amplifier (PPA) 515. The PPA 515 may be a bank of NMOS transistor switches operating as a near class E radio frequency power amplifier, for example. After amplification by the PPA 515, the amplitude and phase signals may then be provided to a power amplifier (PA) 520, which may further amplify the amplitude and phase signals to a power level compatible for transmission over-the-air. A duplexer (or a TX/RX switch (TRS)) 525 may enable the sharing of an antenna 530 by both the digital polar transmitter 500 and a receiver.

The APTAC 502 includes a low noise amplifier 550 that may be used to amplify the transmission made by the digital polar transmitter 500. A transmission made by the digital polar transmitter 500, r(t), may be provided to the APTAC 502 by an electrical connection to the PA 520 or the duplexer 525. At the input to the APTAC 502, the transmission made by the digital polar transmitter 500 r(t) may be expressed as:

r(t)=λ cos(φ+ω_{c}t)+A(t)cos(ω_{c}t+φ(t)),

where t is time index, λ is the magnitude of the LO leakage signal, φ is the additive phase delay of the LO leakage signal, ω_{c} is the carrier frequency, A(t) is the amplitude modulation, and φ(t) is phase modulation. The amplitude modulation A(t) is the analog domain continuous-time equivalent of the interpolated and sampled rho (ρ) signal at the cordic output. Similarly cos(ω_{c}t+φ(t)) is the continuous-time modulated DCO output achieved by two-point modulation of ADPLL using the processed version of cordic output phase, theta (θ).

Alternatively, the APTAC 502 may receive the transmission made by the digital polar transmitter 500 r(t) through mutual inductance (also commonly referred to as parasitic coupling). Mutual inductance is when a signal carried on a first conductive trace creates a current and voltage on a second conductive trace. The current/voltage created on the second conductive trace may substantially be an image of the signal carried on the first conductive trace. Alternatively, a signal detector may be placed in or near the PA 520 to detect the transmission of the digital polar transmitter 500 r(t). A signal detected by the signal detector may then be provided to the APTAC 502. A similar effect may also be achieved using capacitive or resistive coupling under a relatively different set of operating conditions. Capacitive and/or resistive coupling is considered to be well understood by those of ordinary skill in the art and will not be discussed further herein.

After amplification by the LNA 550, the transmission made by the digital polar transmitter 500 r(t) may then be provided to a second order nonlinearity 555. The second order nonlinearity 555 may be used recover a baseband signal in situations where there are low amounts of modulation applied to a radio frequency signal. In addition to the second order nonlinearity 555, a mixer may be used for recovery of the baseband signal. The second order nonlinearity 555 or the mixer may be used since the clock of the digital polar transmitter 500 is a modulated clock. Therefore, a simple down conversion may not be able to accurately recover the baseband signal from the radio frequency signal. The output of the second order nonlinearity e(t) (assuming that there is no DC term) may be expressed as:

$$\begin{matrix}e ( t ) = {c}_{1} ( λ cos ( φ + {ω}_{c} t ) + A ( t ) cos ( {ω}_{c} t + ϕ ( t ) ) ) + \\ {{c}_{2} ( λ cos ( φ + {ω}_{c} t ) + A ( t ) cos ( {ω}_{c} t + ϕ ( t ) ) )}^{2} \\ = λ {c}_{1} cos ( φ + {ω}_{c} t ) + A ( t ) {c}_{1} cos ( {ω}_{c} t + ϕ ( t ) ) ) + \\ \frac{{c}_{2}}{2} ( \begin{matrix}{λ}^{2} + {A ( t )}^{2} + {λ}^{2} cos ( 2 φ + 2 {ω}_{c} t ) + 2 λ A ( t ) cos ( φ - ϕ ( t ) ) + \\ 2 λ A ( t ) cos ( φ + 2 {ω}_{c} t + ϕ ( t ) ) + {A ( t )}^{2} cos ( 2 ϕ ( t ) + 2 {ω}_{c} t )\end{matrix} ) .\end{matrix}$$

The term 2λA(t)cos(φ−φ(t)) in e(t) may provide a baseband error signal energy and may be used to generate an error signal that may be used to tune the timing of the two separate signal paths to minimize the difference in the time alignment of the amplitude and phase signal paths.

The output of the second order nonlinearity e(t) may then be digitized by an analog-to-digital converter (ADC) 560 and filtered by a rate change filter (RCF) 565. The digitized and filtered output of the second order nonlinearity e(t) may then be provided to a signal/modulation metric unit 570. The signal/modulation metric unit 570 may also have the pulse shape filtered in-phase and quadrature phase signals from the pulse shaping filters 205 as input. The signal/modulation metric unit 570 may compute a quality metric that may be an indicator of the time alignment of the signal paths in the digitized and filtered output of the second order nonlinearity e(t). The signal/modulation metric unit 570 may compute a signal energy error based on the digitized and filtered output of the second order nonlinearity e(t) as well as the pulse shape filtered in-phase and quadrature phase signals. Examples of the signal energy error may include the EVM, the ACLR, and/or the ACPR. The error source may also be derived using other statistical signal comparison metrics including but not limited to moments, cumulants, and measured based on statistical signal norms.

The signal energy error, as computed by the signal/modulation metric unit 570 may then be provided to an adaptive algorithm unit 575. The adaptive algorithm unit 575 may make use of the signal energy error to generate a digital control word (DCW) that may be used to adjust the timing of the signal paths. The adaptive algorithm unit 575, which may be single- or multi-tap, creates the DCW to reduce the signal energy error, for example. The adaptive algorithm unit 575 may also store a history of the signal energy error as provided by the signal/modulation metric unit 570 so that it may be able to better create the DCW. For example, the use of the history information may enable the adaptive algorithm unit 575 to better spot trends or irregular behavior, which may otherwise trick the adaptive algorithm unit 575 into creating a DCW that may not result in a reduction of the signal energy error. The adaptive algorithm unit 575 may use a slow adaptation algorithm since it may be unlikely that the time alignment between the signal paths will change dramatically or rapidly. The algorithm may also support a tracking mode in which the slow temporal variations of the initial adaptation results may be tracked. The adaptive algorithm unit 575 may implement algorithms such as least means square (LMS), means square (MS), gradient algorithms, and so forth.

A decoder 580 may then be used to decode the DCW generated by the adaptive algorithm unit 575 into signals that may be used to adjust the timing of the signal paths. For example, if the adaptive algorithm unit 575 generates a DCW to advance the timing of the phase signal path a specified amount of time, the decoder 580 may convert the DCW into signals or sequences of signals to advance the phase signal path by the specified amount of time. The signals generated by the decoder 580 may be provided to a timing adjust unit 585. The timing adjust unit 585 may add or remove delays in the signal paths of the digital polar transmitter 500.

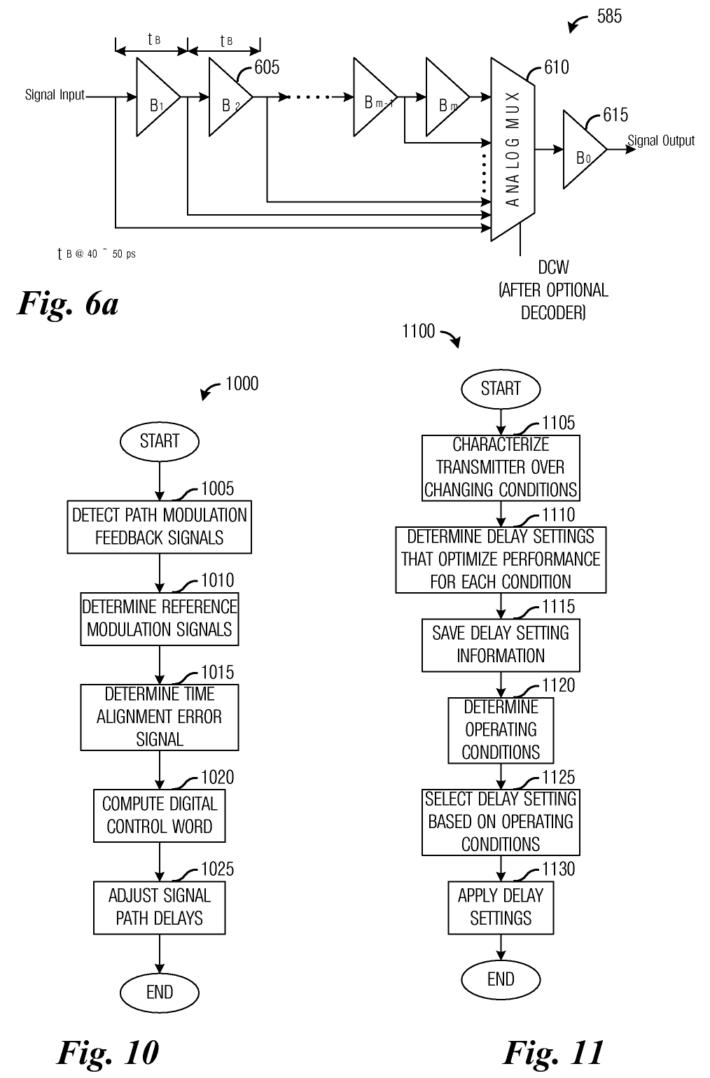

FIG. 6a illustrates a detailed view of a portion of the timing adjust unit 585. The timing adjust unit 585 includes a sequence of buffers, such as buffer 605. The sequence of buffers may have a signal input coupled to one of the signal paths of the digital polar transmitter 500, such as the phase signal path. The buffers in the sequence of buffers may be substantially identical and may impart a known delay t_{B}. A typical value for t_{B} is on the order of a few picoseconds. The timing adjust unit 585 also includes a multiplexer 610. The multiplexer 610 may have a number of inputs, with each input coupled to an output of a different buffer in the sequence of buffers. The multiplexer 610 may have a control input coupled to the decoder 580, which may decode the DCW and then provide the decoded DCW to the multiplexer 610.

Alternatively, the digital control word may be provided directly to the multiplexer 610 from adaptive algorithm unit 575. The control input from the decoder 580 may then select a delayed version of the signal path that includes the timing adjust unit 585. For example, if the adaptive algorithm unit 575 wishes to retard the timing of the phase signal path by an amount about equal to five times the delay of the buffer 605, then the decoder 580 may provide a control input to the multiplexer 610 that may select the output of the fifth buffer in the sequence of buffers. The timing adjust unit 585 may also include an output buffer 615 that may be used to buffer the output of the multiplexer 610. The timing adjust unit 585 may also have substantially identical hardware (sequence of buffers, multiplexer 610, and output buffer 615) for the remaining signal paths in the digital polar transmitter 500.

FIG. 6b illustrates an alternative implementation of the timing adjust unit 585. The timing adjust unit 585 may be implemented by controlling a power supply 605 of a buffer 610 using a DAC 615, for example. As the power supply 605 to the buffer 610 is varied under digital or analog control, the delay through the buffer 610 may be controlled to the resolution provided by the number of bits in the control.

Referring back to FIG. 5, reusing existing hardware may reduce the need for additional hardware in the digital polar transceiver. The LNA 550, the second order nonlinearity 555, the ADC 560, and the RCF 565 may be dedicated circuits in the digital polar transceiver that may be used in forming an auxiliary receiver. However, a typical receiver may also include a LNA, a mixer, an ADC, and a filter. Therefore, it may be possible to utilize a dedicated on-chip receiver to perform the processing of the transmission made by the digital polar transmitter 500 r(t). For example, if the digital polar transceiver is operating in half-duplex mode, it may have a dedicated on-chip receiver that may be idle while the digital polar transmitter 500 is transmitting. The dedicated on-chip receiver may then be used to perform the processing of the transmission made by the digital polar transmitter 500 r(t). Alternatively, if the digital polar transceiver has a secondary receiver, then the secondary receiver may be used as the auxiliary receiver to perform the processing of the transmission made by the digital polar transmitter 500 r(t), regardless of the status of the dedicated on-chip receiver. For a detailed description of secondary receivers, please refer to co-assigned patent application, U.S. patent application Ser. No. 11/595,101, entitled “Methods and Apparatus to Provide an Auxiliary Receive Path to Support Transmitter Functions,” which application is hereby incorporated herein by reference. In addition to a secondary receiver, if the digital polar transceiver may include an LNA, a mixer, an ADC, and/or a filter that may not be busy, some or all of these circuits may be used in time alignment.

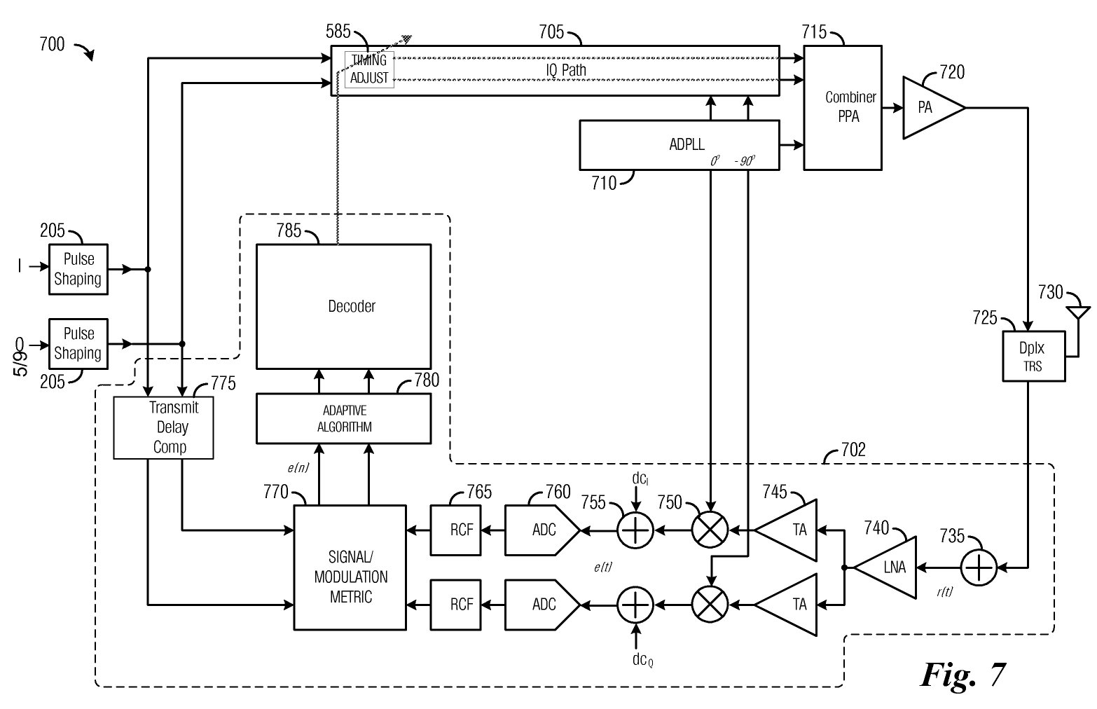

FIG. 7 illustrates a diagram of a Cartesian transmitter 700 of a Cartesian transceiver having an in-phase and quadrature phase signal path time alignment circuit (IQTAC) 702. The diagram of the Cartesian transmitter 700 is a high-level diagram, providing a block-level view of the Cartesian transmitter 700. The Cartesian transmitter 700 includes pulse shaping filters 205, one each for in-phase (I) and quadrature phase (Q) signal paths provided by a digital baseband processor, such as the digital baseband processor 120. The pulse shaping filters 205 may be used to band limit the I and Q signals, for example. Since the Cartesian transmitter 700 makes use of I and Q signals, there may not be a need to convert the I and Q signals into amplitude and phase signals.

The I and Q signals may then be provided to an IQ signal path 705, which may contain separate signal paths for the I and Q signals. The IQ signal path 705 may include a predistortion unit, an interpolation unit, filters, amplifiers, and so forth. The Cartesian transmitter 700 also includes an all digital phase-locked loop (ADPLL) 710. The ADPLL 710 may be used to generate a quadrature local oscillator (LO) reference signal for the Cartesian transmitter 700, for example. The LO may be used as the reference signal for both the I and Q signal paths in the IQ signal path 705.

After processing in their respective signal paths in the IQ signal path 705, the I and Q signals may be provided to a combiner and pre-power amplifier (PPA) 715. The combiner and PPA 715 may be used to combine the I and Q signals in to data symbols as well as amplify the data symbols. The amplified data symbols may receive additional amplification in a power amplifier (PA) 720. A duplexer (or alternately a TRS) 725 may enable the sharing of an antenna 730 by both the Cartesian transmitter 700 and a receiver. The explanation of the Cartesian transmitter 700 is for discussion purposes only, a combination of the I and Q paths and the pre-PA processing may also be utilized in other commonly known Cartesian transmitter configurations.

The IQTAC 702 includes a low noise amplifier 740 that may be used to amplify the transmission made by the Cartesian transmitter 700. A transmission made by the Cartesian transmitter 700 may be provided to the IQTAC 702 by an electrical connection to the PA 720 or the duplexer 725. A summing point 735 combines the transmission made by the Cartesian transmitter 700 along with other signals, such as signals induced at the IQTAC 702 by mutual inductance (or parasitic coupling). An input signal to the IQTAC 702 (an output of the summing point 735, r(t)) may include the transmission made by the Cartesian transmitter 700, along with noise and interference, as well as replicas (possibly attenuated, distorted, or otherwise altered) of the transmission made by the Cartesian transmitter 700.

A low noise amplifier (LNA) 740 may be used to amplify the input signal to the IQTAC 702. The amplified input signal to the IQTAC 702 may then be provided to two distinct signal paths, one each for the I and Q signals. The following discussion focuses on one of the two signal paths. However, the two signal paths are substantially identical and the discussion of one signal path will adequately describe both signal paths.

The amplified input signal to the IQTAC 702 may then be provided to a transconductance amplifier (TA) 745, which may output a current proportional to a voltage at its input. The current proportional to the amplified input signal to the IQTAC 702 may then be provided to a mixer 750. The mixer 750 may be coupled to the ADPLL 710 and may be used to down convert the current that may be a radio frequency (RF) signal directly into a baseband signal, or alternately first into an internal frequency (IF) signal and then into the base-band signal in a following stage. Since in a Cartesian transmitter, the clocks are not modulated clocks, down conversion of the amplified input signal to the IQTAC 702 will reproduce the baseband I/Q signals.

An adder 755 may be used to remove any DC offset present in the down converted signal produced by the mixer 750. The down converted signal contains phase information that may be used to determine a time alignment between the I and Q signals. The down converted signal may then be digitized and filtered by an analog-to-digital converter (ADC) 760 and a rate change filter (RCF) 765.

The digitized and filtered signal may then be provided to a signal/modulation metric unit 770 that may compute a signal energy error based on the digitized and filtered signal as well as a delay compensated version of the I and Q signals (delayed by a transmit delay compensation unit 775). Examples of the signal energy error may include the EVM, the ACLR, and/or the ACPR.

The signal energy error, as computed by the signal/modulation metric unit 770 may then be provided to an adaptive algorithm unit 780. The adaptive algorithm unit 780 may make use of the signal energy error to generate a digital control word (DCW) that may be used to adjust the timing of the signal paths. The adaptive algorithm unit 780 creates the DCW to reduce the signal energy error, for example. The adaptive algorithm unit 780 may also store a history of the signal energy error as provided by the signal/modulation metric unit 770 so that it may be able to better create the DCW. For example, the use of the history information may enable the adaptive algorithm unit 780 to better spot trends or irregular behavior, which may otherwise trick the adaptive algorithm unit 780 into creating a DCW that may not result in a reduction of the signal energy error. The adaptive algorithm unit 780 may implement algorithms such as least means square (LMS), means square (MS), a gradient, and so forth.

A decoder 785 may then be used to decode the DCW generated by the adaptive algorithm unit 780 into signals that may be used to adjust the timing of the signal paths. For example, if the adaptive algorithm unit 780 generates a DCW to advance the timing of the I (or Q) signal path a specified amount of time, the decoder 580 may convert the DCW into signals or sequences of signals to advance the I signal path by the specified amount of time. The signals generated by the decoder 785 may be provided to the timing adjust unit 585. The timing adjust unit 585 may insert or remove delays in the I and/or Q signal paths of the Cartesian transmitter 700. The timing adjust unit 585 may also be implemented by controlling a power supply 605 of a buffer 610 using a DAC 615, for example. As the power supply 605 to the buffer 610 is varied under digital or analog control, the delay through the buffer 610 may be controlled to the resolution provided by the number of bits in the control.

Reusing existing hardware may reduce the need for additional hardware in the digital polar transceiver. The LNA 740, the TA 745, the mixer 750, the adder 755, the ADC 760, and the RCF 765 may be dedicated circuits in the Cartesian transceiver that may be used in forming an auxiliary receiver. However, a receiver typically will also include a LNA, a TA, a mixer, an adder, an ADC, and a filter. Therefore, it may be possible to utilize a dedicated on-chip receiver to perform the processing of the transmission made by the Cartesian transmitter 700. For example, if the Cartesian transceiver is operating in half-duplex mode, it may have a dedicated on-chip receiver that may be idle while the Cartesian transmitter 700 is transmitting. The dedicated on-chip receiver may then be used to perform the processing of the transmission made by the Cartesian transmitter 700. Alternatively, if the Cartesian transceiver has a secondary receiver, then the secondary receiver may be used to perform the processing of the transmission made by the Cartesian transmitter 700, regardless of the status of the dedicated on-chip receiver. In addition to a secondary receiver, if the Cartesian transceiver includes a LNA, a TA, a mixer, an adder, an ADC, and/or a filter that may not be busy, some or all of these circuits may be used in time alignment.

Directly measuring a signal energy error (such as EVM, ACLR, or ACPR) may require the use of additional circuitry that may not ordinarily be present in a transceiver. Even if the circuitry is present, some or all of the circuitry may not be available for use in measuring the signal energy error. For example, in a digital polar transceiver a LNA, a mixer, an ADC, and a filter may be required, while in a Cartesian transceiver a LNA, a TA, a mixer, an adder, an ADC, and a filter may be required. If these circuits are not available or available for use in the transceiver, then they may need to be added, which may increase the complexity, cost, and size of the transceiver.

The processing of an error signal indicative of the time alignment mismatch in the digital polar transmitter 500 or the Cartesian transmitter 700 may also be performed in software executing on an on-chip processor, such as the script processor 125 (FIG. 1). An updating of the DCW may be equivalently achieved by a processor write to control a delay between the amplitude and phase paths or the in-phase and quadrature phase paths of a digital polar transmitter or Cartesian transmitter, respectively.

However, for a digital polar transmitter, it may be possible to use an alternate time alignment error source, which may not require the extra hardware needed for the direct measurement of the signal energy error from the digital polar transmitter's output. The reduction in hardware may result in a smaller digital polar transceiver with increased reliability and decreased power consumption, both due to a total reduction in hardware.

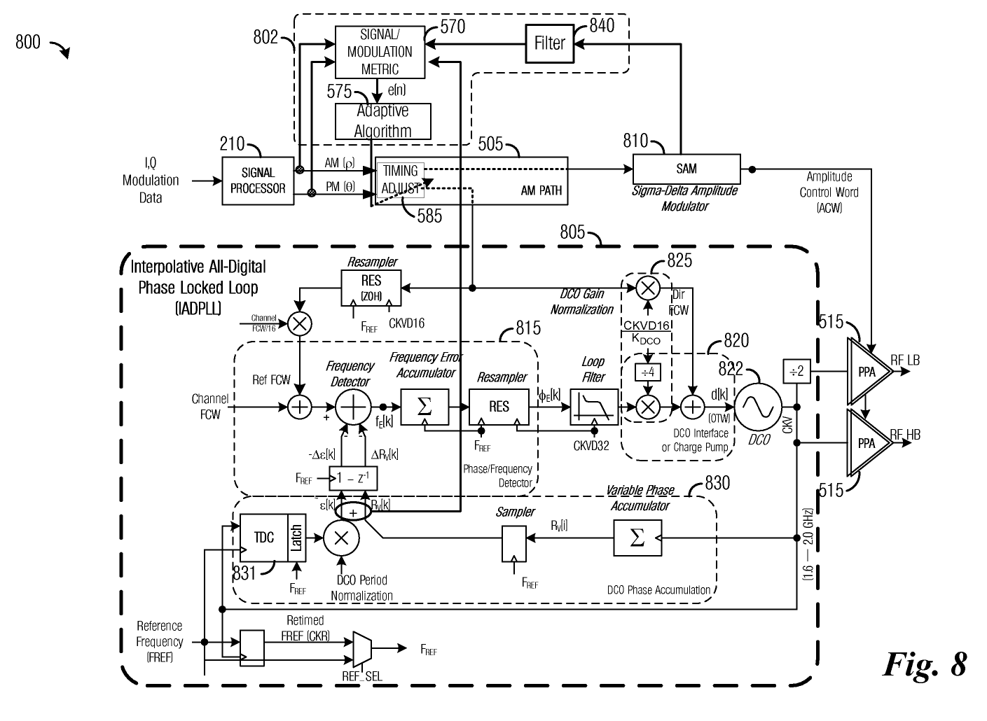

FIG. 8 illustrates a diagram of a digital polar transmitter 800 of a digital polar transceiver. The digital polar transmitter 800 makes use of an alternate error source in its amplitude and phase signal path time alignment circuit (APTAC) 802. The digital polar transmitter 800 includes a signal processor 210 for use in converting I and Q signals into amplitude and phase signals using a Cordic algorithm. The digital polar transmitter 800 also includes an AM signal path 505 and an interpolative all digital phase-locked loop (IADPLL) 805. The AM signal path 505 may be used for processing of the amplitude signal, while the IADPLL 510 may be used for processing of the phase signal as well as providing a local oscillator (LO) reference signal.

After processing by the AM signal path 505, the amplitude signal may be modulated by a sigma-delta amplitude modulator (SAM) 810. The SAM 810 may produce amplitude control words (ACW) from the amplitude signal. The ACW may be provided to a pre-power amplifier (PPA) 515 to amplitude modulate a phase modulated signal. There may be either a separate or a converged PPA 515 for both low-band signal and high-band signal(s). FIG. 8 displays a separate PPA 515 for the low-band signal and the high-band signal. The amplitude and phase modulated output of the PPA 515 may then be provided to a PA for additional amplification for transmission purposes.

The IADPLL 805 includes a phase-frequency detector 815, a digitally controlled oscillator (DCO) interface 820, a DCO gain normalization unit 825, and a DCO phase accumulator 830. The phase-frequency detector 815 may be used to generate a signal that may be representative of a difference between signals at its input. The phase-frequency detector 815 generates a signal φ_{E}[k] that may be representative of a difference between a reference phase (R_{R}[k]), a variable phase (R_{V}[k]), and a fractional error correction term (ε[k]). The DCO interface 820 may be used to generate an oscillator tuning word (OTW) that may be used to tune the oscillating frequency of a DCO 822.

The DCO gain normalization unit 825 may decouple the phase and frequency information throughout the IADPLL 805 from process, voltage, and temperature variations normally affecting oscillator gain (K_{DCO}). Collectively, the DCO 822 along with an equivalent DCO gain normalization multiplication of

$$\frac{{f}_{v} / 16}{{\hat{K}}_{DCO}} = \frac{{f}_{v} / 16}{{F}_{R}} • \frac{{f}_{R}}{{\hat{K}}_{DCO}}$$

may logically comprise a normalized DCO (nDCO), where fᵥ/16 is the injection frequency and may be the update rate of the DCO interface 820. The DCO phase accumulator 830 generates the variable phase (R_{V}[k]). A time-to-digital converter (TDC) 831 generates the fractional error correction term (ε[k]), which provides a sub-DCO clock phase difference between the reference frequency and the DCO output clock.

In an alternate embodiment of APTAC 802 for the digital polar transmitter 800, an alternate time alignment error signal energy source may be used in the APTAC 802 to determine a time alignment between the separate amplitude and phase signal paths. For the digital polar transmitter 800, the output of the DCO phase accumulator 830: the variable phase (R_{V}[k]) and the fractional error correction term (ε[k]) contains the phase modulation information. The phase modulation information may be derived after compensation for the slow drift in the DCO and the LO phase noise caused by a DCO tank as well as the IADPLL 805. The APTAC 802 includes the signal/modulation metric unit 570 that may have as input a combination of the output from the DCO phase accumulator 830 (R_{V}[k]+ε[k]), which may provide phase modulation feedback information, as well as an output of the SAM 810 after filtering by a filter 840, used to delay the amplitude signal by the equivalent of the amplitude path delay to the PPA 515 as well as reconstruct the amplitude signal. The signal/modulation metric unit 570 may then compute an error signal, such as the EVM, the ACLR, and/or the ACPR, from R_{V}[k+ε[k] and the filtered output from the SAM 810. The filtered output from the SAM 810 may be interpolated or dithered amplitude information. The error signal may then be provided to the adaptive algorithm unit 575, which may generate a digital control word (DCW) from the error signal to adjust the timing of the signal paths by way of the timing adjust unit 585.

The use of signals from the IADPLL 805 and the SAM 810 internal to the digital polar transmitter 800 has reduced the need for additional circuitry in the digital polar transceiver, as described previously. This may result in considerable power savings as a significant amount of hardware may be eliminated. However, for a digital polar transmitter, this assumes that the variations in the analog timing delay of the amplitude path (i.e., the path from the output of the SAM 810 to the output of the DPA 515) is either relatively small or is adequately characterized in order to create an adequate time alignment error signal using the filter 840 along with the IADPLL 805 estimated phase modulation and a comparison with reference amplitude and phase signals from the digital polar transmitter 800.

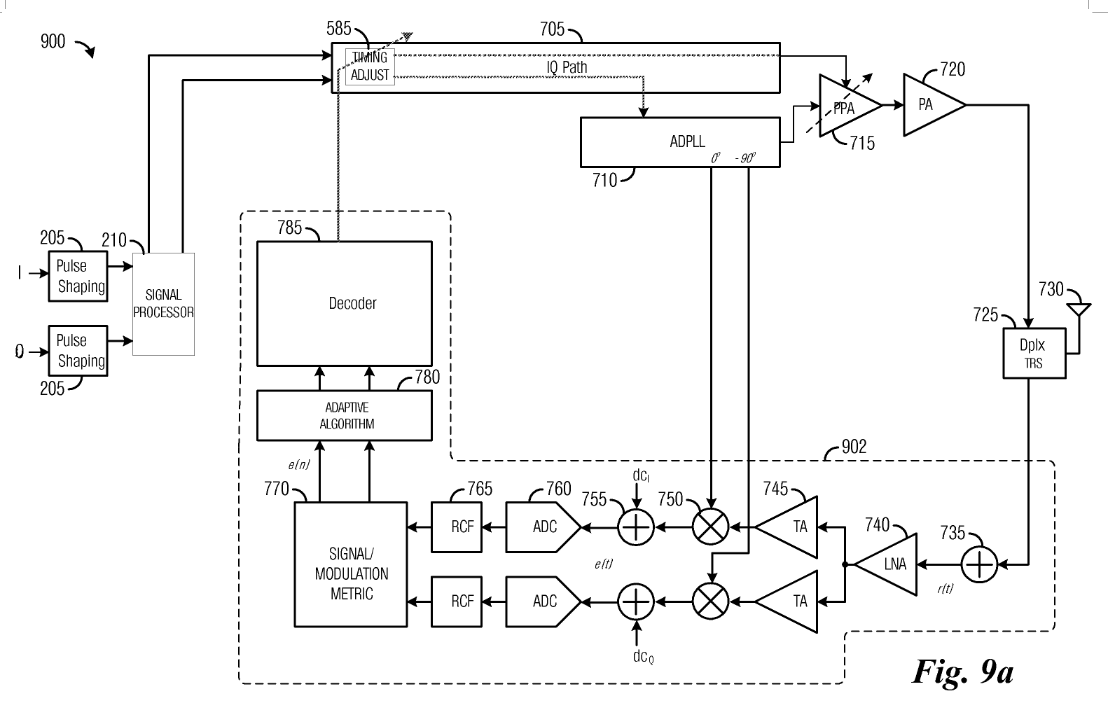

FIG. 9a illustrates a diagram of a small signal digital polar transmitter 900. The small signal digital polar transmitter 900 makes use of a time alignment circuit (TAC) 902 having a similar configuration to the IQTAC 702 of the Cartesian transmitter 700. The amplitude modulation may be applied through the PPA 715.

FIG. 9b illustrates a diagram of a large signal digital polar transmitter 970. The small signal digital polar transmitter 900 makes use of a time alignment circuit (TAC) 902 having a similar configuration to the IQTAC 702 of the Cartesian transmitter 700. The amplitude modulation may be applied at the PA 720 by modulating a power supply, for example.

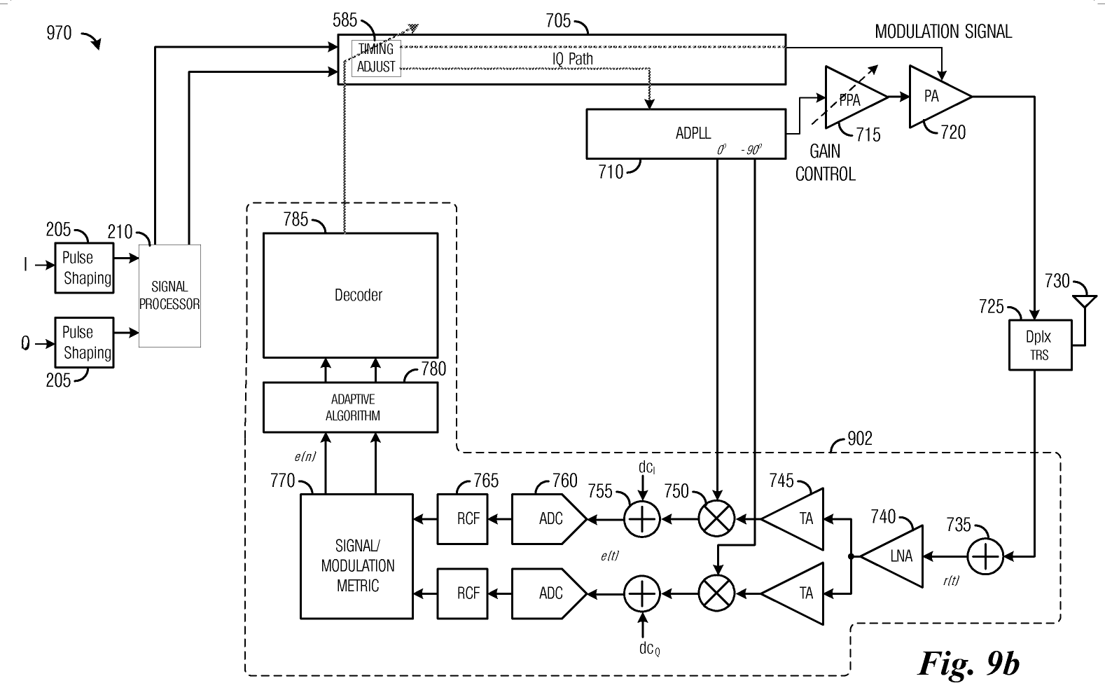

FIG. 10 illustrates a sequence of events 1000 for use in adjusting time alignment between separate signal paths of a transmitter. The adjusting of time alignment between separate signal paths may occur continuously during operation of the transmitter. Alternatively, the adjusting may occur during system power up, as well as at the occurrence of specified events, such as the elapsing of specified amounts of time, availability of inter-slot or inter-burst times, prior to establishing a communications connection, when a measured performance metric meets or exceeds a specified threshold, when an error rate meets or exceeds a specified threshold, and so forth.

The adjusting of time alignment may begin with a detecting of path modulation feedback signal (block 1005). In transmitters with dedicated time alignment circuitry, such as the APTAC 502 and the IQTAC 702, the path modulation feedback signals may be detected from a baseband signal derived from a transmission made by the transmitter. The APTAC 502 and the IQTAC 702 may use an idle dedicated on-chip receiver, a secondary receiver, an auxiliary receiver, or dedicated circuitry contained in a transceiver containing the transmitter. Reference modulation signals may also be determined (block 1010). Reference modulation signals may be delayed versions of data from baseband processors, for example.

From the path modulation feedback signals and the reference modulation signals, a time alignment error signal may be determined (block 1015). The computing of the error signal may be accomplished in a signal/modulation metric unit, such as the signal/modulation metric unit 570 and 770. The path modulation feedback signals may be used to determine an error signal energy and in combination with the reference modulation signals, the time alignment error signal may be determined.

In a transmitter that uses an IADPLL, ADPLL, or PLL in place of the dedicated time alignment circuitry, such as the digital polar transmitter 800, the error signal energy may be determined from the phase accumulator 830 of the IADPLL, for example. Therefore, the use of an IADPLL, ADPLL, or PLL in place of the dedicated time alignment circuitry may enable an elimination of the detecting of path modulation feedback signals (block 1005).

The error signal may then be provided to an adaptive algorithm unit, such as the adaptive algorithm unit 575 and 580, wherein the adaptive algorithm unit may use the error signal in generating a digital control word (DCW) (block 1020). The DCW may be intended to reduce the error signal energy. The adaptive algorithm unit may use an adaptive algorithm, such as least means squared, means squared, gradient algorithms, and so forth to generate the DCW. The DCW may then be provided to a decoder, such as the decoder 580 and 775, which may turn the DCW into control signals that may be used in adjusting delays in the separate signal paths (block 1025).

In addition to the closed loop systems and techniques described above for adjusting time alignment between separate signal paths, it may be possible to use an open loop technique for adjusting time alignment between separate signal paths. The use of an open loop technique may be possible since the time alignment between separate signal paths may be unlikely to change dramatically or quickly once time alignment is achieved.

FIG. 11 illustrates a sequence of events 1100 for use in open loop adjusting of time alignment between separate signal paths of a transmitter. The adjusting of time alignment between separate signal paths may occur during system power up, as well as at the occurrence of specified events, such as the elapsing of specified amounts of time, prior to establishing a communications connection, when a measured performance metric meets or exceeds a specified threshold, when an error rate meets or exceeds a specified threshold, and so forth. Alternatively, the adjusting may occur continuously while the transmitter is in operation.

The adjustment of time alignment between separate signal paths may be estimated or carried out as part of the characterization of a transmitter, such as a digital polar transmitter or a Cartesian transmitter, over a range of conditions (block 1105). The characterization may occur during a manufacture of the transmitter or during testing and calibration of the transmitter. The range of conditions may include expected process variations, operating temperature ranges, operating voltages, operating frequencies, and so forth. The number of combinations of different conditions over which the characterization is performed may be based on an amount of memory in the transmitter to be dedicated to the characterization information, the amount of characterization time and money allotted to each transmitter, and so on. The characterization may include a determination of delay settings for the separate signal paths that optimizes the performance of the transmitter (block 1110). Once characterized, the characterization information may be stored in a memory in the transmitter for later use (block 1115). The characterization information may be organized in a lookup table form to help simplify retrieval or implemented using a functional mapping or approximation, for example.

As discussed above, the characterization of the transmitter over a range of conditions may occur during the manufacture or testing of the transmitter and then stored in memory. Then, under normal operating conditions, the adjusting of time alignment may occur by first determining the operating condition of the transmitter (block 1120). For example, process variations may be determined by examining an inverter delay or an efuse, temperature may be determined by a temperature sensor, and operating frequency may be determined by a frequency control word in an ADPLL. From the operating conditions, the characterization information, such as delay settings, may be retrieved from the memory, for example, a lookup table or a functional mapping (block 1125). The characterization information may then be applied (block 1130).

Although the embodiments and their advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A transmitter having two signal paths, the transmitter comprising:
a first signal path coupled to a first data input, the first signal path configured to process a first data stream for transmission;
a second signal path coupled to a second data input, the second signal path configured to process a second data stream for transmission;
an error signal energy source coupled to the first signal path and to the second signal path, the error signal energy source configured to generate an error signal responsive to a time alignment difference between the first data stream and the second data stream;
a time alignment circuit coupled to the error signal energy source and to the first data input and to the second data input, the time alignment circuit configured to generate a digital control word responsive to the error signal and to the first data stream and to the second data stream; and
a timing adjust unit coupled to the time alignment circuit and to the first signal path and to the second signal path, the timing adjust unit configured to insert a delay proportional to the digital control word in at least one of the first signal path or the second signal path.

2. The transmitter of claim 1, wherein the time alignment circuit generates the digital control word responsive to the error signal and previously generated error signals to reduce the time alignment between the first data stream and the second data stream.

3. The transmitter of claim 2, wherein the time alignment circuit comprises an adaptive algorithm unit coupled to the error signal energy source, the adaptive algorithm unit configured to implement an adaptive algorithm to reduce the time alignment.

4. The transmitter of claim 3, wherein the adaptive algorithm is a least means squared algorithm, a means squared algorithm, or a gradient algorithm.

5. The transmitter of claim 1, wherein the transmitter is a digital polar transmitter, and wherein the error signal energy source comprises:
a second order linearity coupled to a transmission data input, the second order linearity configured to recover a baseband signal from a transmission made by the transmitter;
a digitizer coupled to the second order linearity, the digitizer to digitize the baseband signal; and
a metric unit coupled to the digitizer, the metric unit configured to generate the error signal from the baseband signal.

6. The transmitter of claim 5, wherein the second order linearity is a mixer.

7. The transmitter of claim 5, wherein the transmission data input comprises a direct electrical connection from an output of the transmitter or a mutually inductive connection from the output of the transmitter.

8. The transmitter of claim 1, wherein the transmitter is a Cartesian transmitter, and wherein the error signal energy source comprises:
a first mixer coupled to a transmission data input, the first mixer configured to recover a first baseband data stream from a transmission made by the transmitter;
a second mixer coupled to the transmission data input, the second mixer configured to recover a second baseband data stream from the transmission made by the transmitter;
a first digitizer coupled to the first mixer, the first digitizer to digitize the first baseband data stream;
a second digitizer coupled to the second mixer, the second digitizer to digitize the second baseband data stream; and
a metric unit coupled to the first digitizer and to the second digitizer, the metric unit configured to generate the error signal from the first baseband data stream and the second baseband data stream.

9. The transmitter of claim 1, wherein the error signal energy source comprises a phase-locked loop, and wherein the error signal is from a phase accumulation block of the phase-locked loop.

10. The transmitter of claim 9, wherein the phase-locked loop is an interpolative all-digital phase-locked loop, and wherein the error signal comprises a variable phase term (R_{V}[k]) and a fractional error correction term (ε[k])

11. The transmitter of claim 10, wherein the error signal further comprising interpolated or dithered amplitude information from a sigma-delta amplitude modulator.

12. The transmitter of claim 1 further comprising a decoder coupled in between the time alignment circuit and the timing adjust unit, the decoder configured to convert the digital control word into a timing adjust unit control signal.

13. The transmitter of claim 1, wherein the timing adjust unit comprises:
a sequence of buffers; and
a multiplexer having multiple signal inputs and a control input, each signal input coupled to an output of a buffer in the sequence of buffers, and the control input coupled to the time alignment circuit, the multiplexer to selectively couple a signal input to an output responsive to the digital control word.

14. The transmitter of claim 13, wherein the buffer in the sequence of buffers are substantially identical.

15. A method for adjusting a time alignment between separate signal paths, the method comprising:
computing a signal metric from data carried on the separate signal paths;
generating a digital control word from the signal metric; and
adjusting a delay in one or more of the separate signal paths responsive to the digital control word.

16. The method of claim 15, wherein computing the signal metric comprises:
detecting an error signal energy from a transmission containing data from the separate signal paths; and
computing the signal metric from the error signal energy and reference signals from the separate signal paths.

17. The method of claim 16, wherein detecting the error signal energy comprises:
converting the transmission into a baseband signal; and
detecting the error signal energy from the baseband signal.

18. The method of claim 15, wherein computing the signal metric comprises:
accumulating a variable phase term;
generating a fractional error correcting term;
generating an error signal energy from the accumulated variable phase term and the fraction error correcting term; and
computing the signal metric from the error signal energy and reference signals from the separate signal paths.

19. The method of claim 18, wherein the error signal energy is also generated from a filtered or dithered output from a sigma-delta amplitude modulator.

20. The method of claim 15, wherein adjusting the delay comprises inserting or removing a delay in one or more of the separate signal paths.

21. A method for adjusting a time alignment between separate signal paths, the method comprising:
characterizing the separate signal paths over a variety of conditions to produce delay settings for the separate signal paths;
saving the delay settings;
determining operating conditions;
retrieving delay settings based on the operating conditions; and
applying the delay settings to the separate signal paths.

22. The method of claim 21, wherein characterizing and saving are computed a priori and stored in a memory.

23. The method of claim 21, wherein the conditions comprise process variations, temperature variations, voltage variations, and operating frequency variations.

24. The method of claim 23, wherein determining operating conditions comprises:
determining process variations by measuring a delay of an inverter;
determining temperature by reading a temperature sensor; and
determining an operating frequency by decoding a frequency control word.

25. The method of claim 21, wherein applying the delay settings comprises inserting or removing delays in the separate signal paths.
